(19) United States
(12) Patent Application Publication
(10) Pub. No.: US 2014/0331451 A1
(43) Pub. Date: Nov. 13, 2014

(54) FURNITURE HINGE

(71) Applicant: Julius Blum GmbH, Hoechst (AT)

(72) Inventor: Andreas HOLZAPFEL, Bregenz (AT)

(21) Appl. No.: 14/340,839

(22) Filed: Jul. 25, 2014

Related U.S. Application Data
(63) Continuation of application No. PCT/AT2013/000002, filed on Jan. 14, 2013.

(30) Foreign Application Priority Data
Feb. 16, 2012 (AT) 192/2012

(51) Int. Cl. E05D 7/00

(52) U.S. Cl. CPC E05D 7/00
USPC 16/286

(57) ABSTRACT

The invention relates to a furniture hinge comprising a hinge arm having a longitudinal axis, a hinge cup that is connected to the hinge arm and is mounted such as to be pivotable relative to the hinge arm between a closed position and an open position, and further comprising a linear damper having a linear damping stroke for damping a movement of the furniture hinge, wherein the linear damper is arranged at the hinge cup and, jointly therewith, can be arranged within a bore of a furniture item in the installed position, wherein in the open position of the furniture hinge in a plan view, the direction of the linear damping stroke of the linear damper runs at an acute angle (alpha) relative to the longitudinal axis of the hinge arm, the acute angle (alpha) being between 3° and 20°.

The present invention concerns a furniture hinge comprising a hinge arm having a longitudinal axis, a hinge cup which is connected to the hinge arm and which is mounted pivotably relative to the hinge arm between a closed position and an open position, and a linear damper having a linear damping stroke for damping a movement of the furniture hinge, wherein the linear damper is arranged at the hinge cup and can be arranged jointly therewith in the installed position within a bore in a furniture part.

The invention further concerns an article of furniture comprising a furniture carcass and a moveable furniture part which is mounted pivotably relative to the furniture carcass by way of at least one furniture hinge of the kind to be described.

The damping action of a linear damper is essentially based on the flow resistance of a damping fluid in a fluid chamber. Damping devices having a piston which involves a linear damping stroke usually have a travel-dependent damping function, that is to say the degree of damping is dependent on the available damping stroke of the piston. Thus, an sufficient damping travel and a suitable piston diameter are therefore to be provided in order to achieve the desired smooth damping of a hinge movement. A particular requirement is therefore that the linear damper is to be arranged on the hinge cup in as compact and inconspicuous fashion as possible, but at the same time the piston diameter and the damping stroke are to be suitably sized for the purposes of optimum damping efficiency.

A furniture hinge with a hinge cup and a linear damper mounted thereon which can be jointly arranged within a circular standard furniture bore is described, for example, in WO 2010/108203 A1 and WO 2008/104009 to the present applicant. In that case, the linear damper or dampers are mounted to an outside wall of the hinge cup, wherein the hinge cup has to be narrower than conventional hinge cups so that the hinge cup and the damper arranged thereon can be jointly fitted within the bore. A hinged lever is provided for acting on the damper, the hinged lever connects the hinge cup with the hinge arm immerses together with the hinge arm into the hinge cup in the closing movement. Therefore, the necessary reduction in size of the hinge cup in accordance with the state of the art means that the hinged lever and the hinge arm connected thereto must also be of a smaller width so that they can be jointly pushed into the hinge cup. Thus the hinge cup, the hinged lever and the hinge arm are made from special constructions (for example with cranked configurations), which is relatively complicated and cost-intensive.

EP 1 931 850 B1 describes furniture hinges having a linear damper, wherein the linear damping stroke is transverse relative to a longitudinal axis of the hinge arm. As those linear dampers and the hinge arm are not disposed within the bore in the furniture part in the mounted position, the structural length of the linear damper can be of relatively great size so that in this case a sufficient piston damping stroke is always available.

WO 2010/108201 A1 describes a furniture hinge having a damping device which can be arranged within a hinge cup. The damping device has two fluid chambers with displaceably mounted pistons, wherein the direction of the linear damping stroke of the first piston extends approximately at a right angle relative to the direction of the linear damping stroke of the second piston.

The object of the present invention is to propose a furniture hinge of the general kind set forth in the opening part of this specification, wherein existing standard forms of the hinge parts (and thus production lines present in the factory) can be used while in addition it is possible to ensure reliable damping efficiency of the linear damper.

According to the invention, that is achieved by the features of claim 1. Further advantageous configurations of the invention are recited in the appendant claims.

According to the invention, it is provided that in the open position of the furniture hinge, in a plan view, the direction of the linear damping stroke of the linear damper extends at an acute angle relative to the longitudinal axis of the hinge arm, the said acute angle being between 3° and 20°.

By way of an arrangement of a linear damper whose linear damping stroke in an open position of the hinge, in a plan view, forms an acute angle relative to a longitudinal axis of the hinge arm provides the advantage that the region of the hinge cup, in which the hinged lever and/or the hinge arm immerse in the closing movement of the furniture hinge, can be widened so that it is also possible to use standard components of the furniture hinge (in particular the hinge cup, the hinged lever which connects the hinge arm to the hinge cup and also the hinge arm). In addition, the structural length and thus the damping stroke can also be increased by virtue of the inclined position of the linear damper.

The linear damper can have at least one fluid chamber with a piston and/or a ram accommodated therein, wherein the high-pressure side of the fluid chamber (that is to say that end portion of the fluid chamber which includes the bottom of the fluid chamber) faces towards the hinge arm, while the other end portion of the fluid chamber with the low-pressure side (that is to say that region of the fluid chamber, from which the ram projects for force actuation of the damper) faces away from the hinge arm.

In an embodiment of the invention, it can be provided that said acute angle—which is included between the longitudinal axis of the hinge arm and the direction of the linear damping stroke of the linear damper—is between 5° and 10°.

In a preferred embodiment, the maximum damping stroke and the piston diameter can respectively be between 4 mm and 6 mm.

The hinge cup can have a fixing flange for bearing against a furniture part, wherein the linear damper is arranged at least partially externally on the hinge cup and in the installed position beneath the fixing flange. The direction of the linear damping stroke of the linear damper, in that case, preferably extends parallel to the contact surface of the fixing flange, which bears against the furniture part.

Further details and advantages of the present invention are described by means of the embodiment illustrated in the Figures in which:

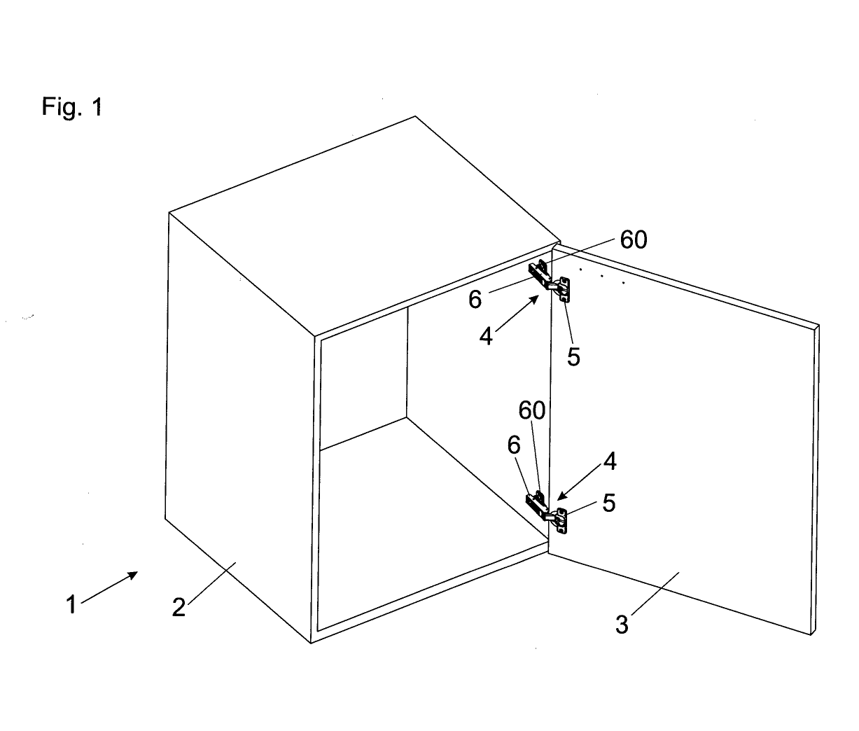

FIG. 1 shows a perspective view of an article of furniture in cabinet form with a pivotably connected door,

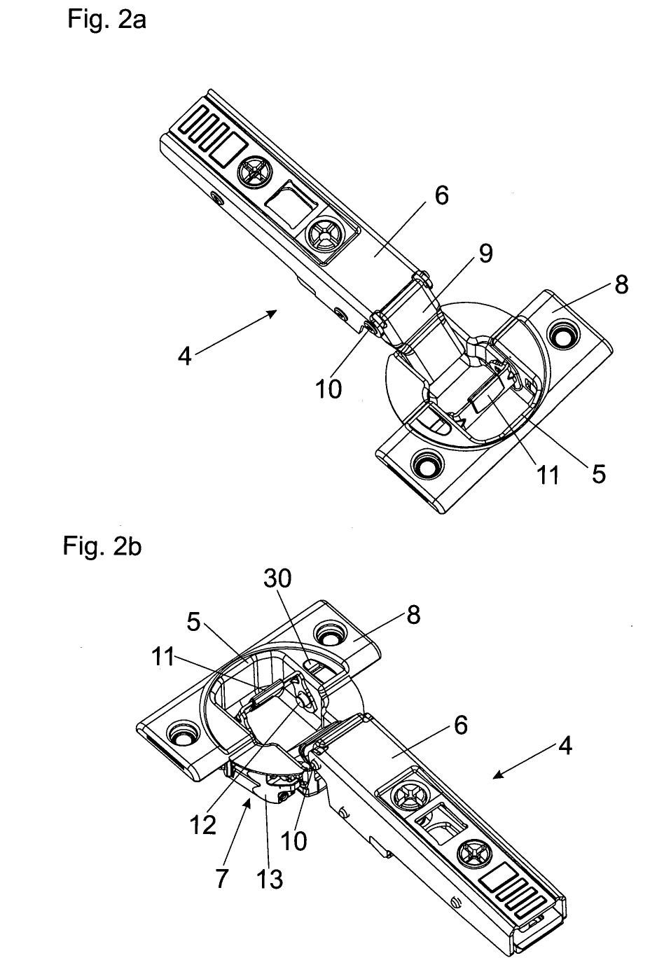

FIGS. 2a, 2b show two different perspective views from above of the furniture hinge,

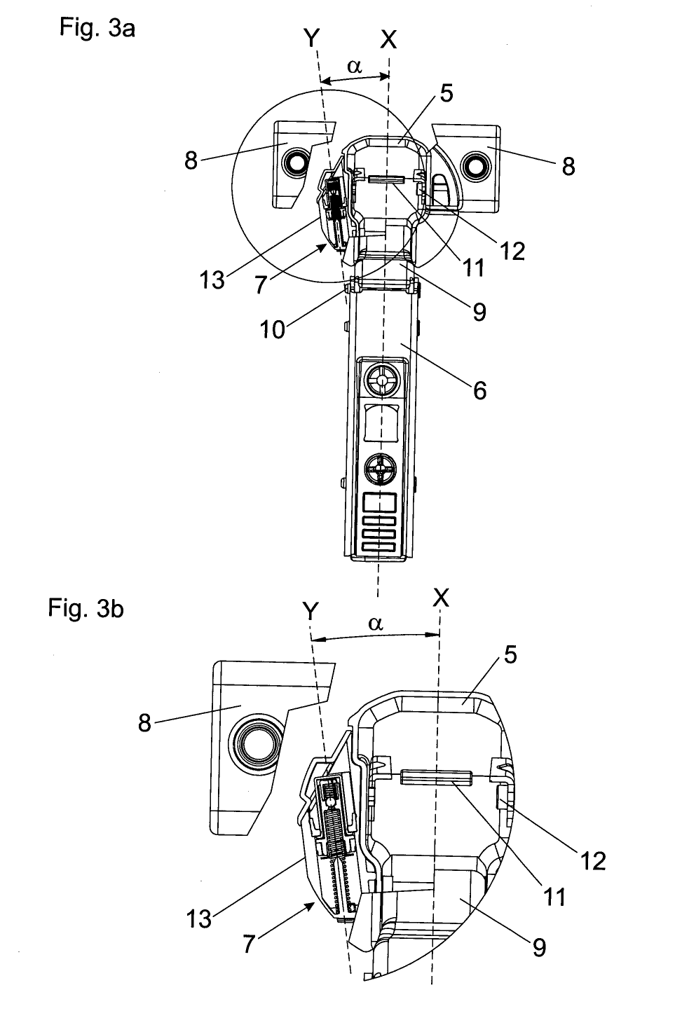

FIGS. 3a, 3b show a plan view of the furniture hinge and an enlarged detail view,

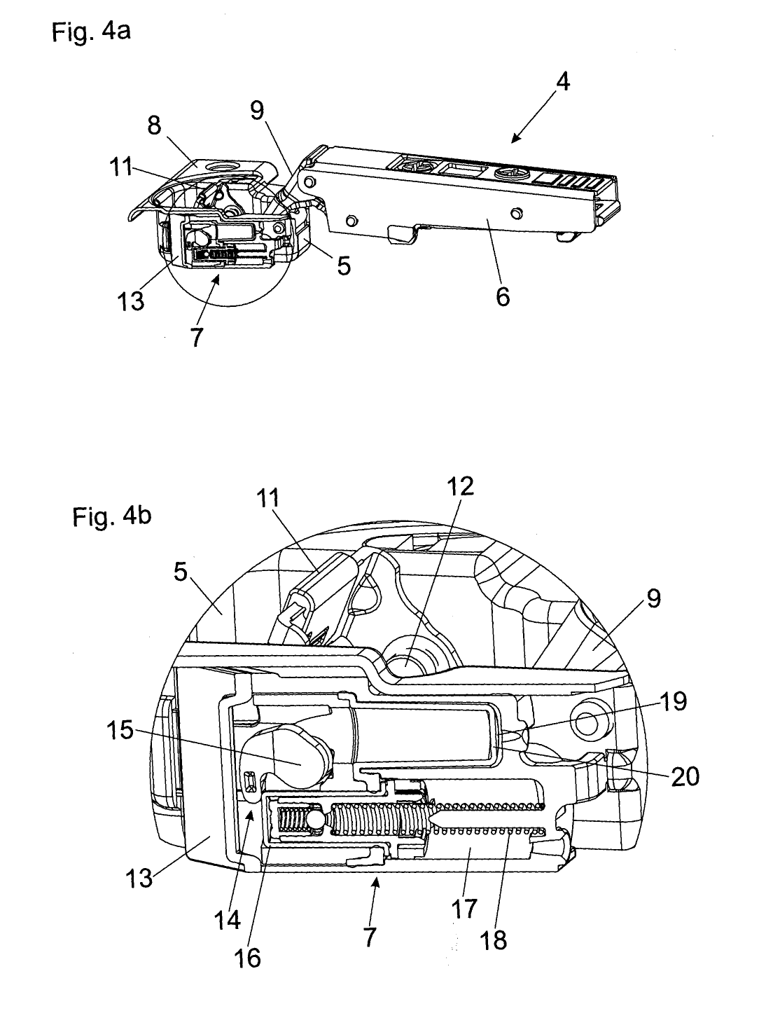

FIGS. 4a, 4b show a perspective view and an enlarged detail view of the furniture hinge in the open position,

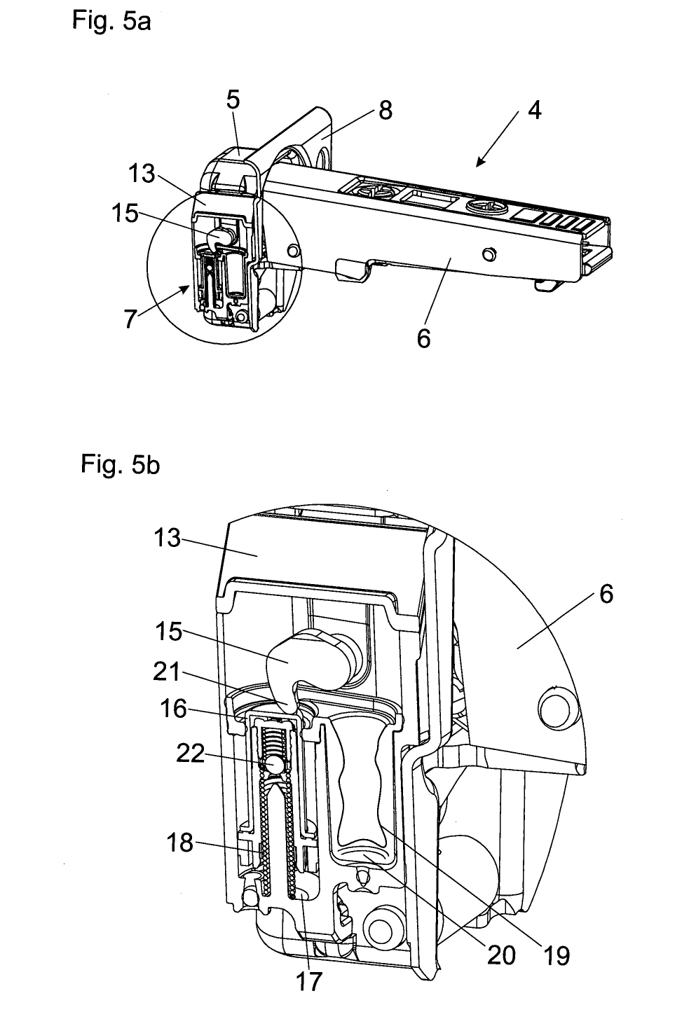

FIGS. 5a, 5b show a perspective view and an enlarged detail view of the furniture hinge in the closed position,

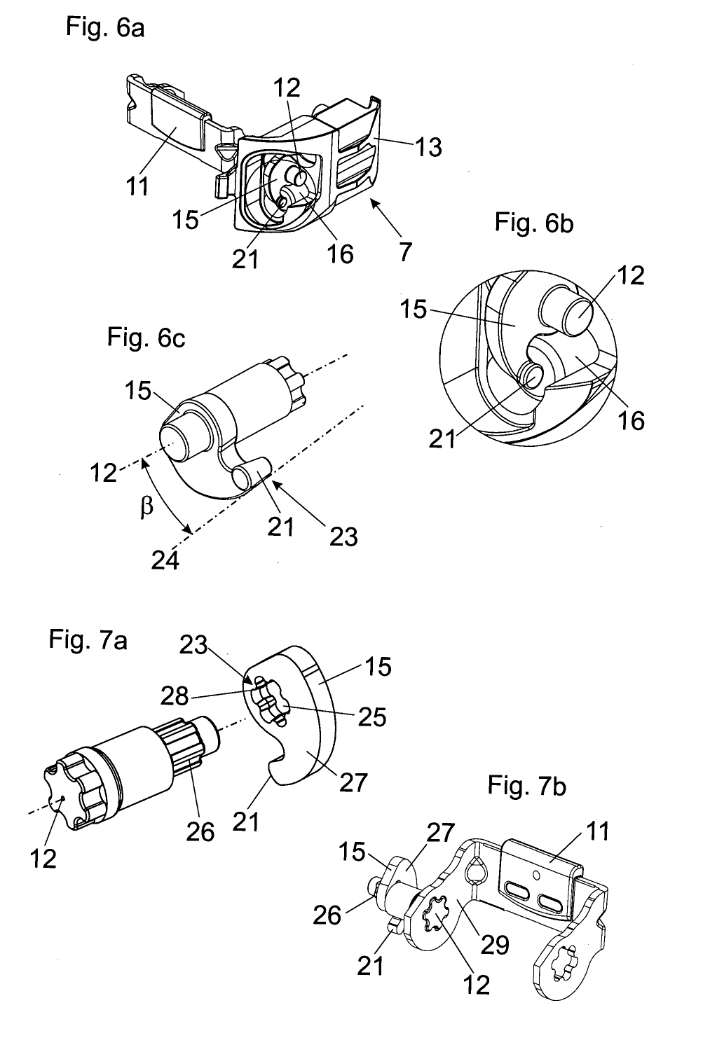

FIGS. 6a-6c show a perspective view and two detail views of the linear damper with an angle compensating device, and

FIGS. 7a, 7b show two different views of a further embodiment of an angle compensating device.

FIG. 1 shows a perspective view of an article of furniture 1, a door 3 being mounted pivotably relative to a furniture carcass 2 by way of furniture hinges 4. In known manner, the furniture hinges 4 have a hinge cup 5 hingedly connected to a hinge arm 6. The hinge cup 5, as commonly known, can be releasably latched to a mounting plate 60 to be fixed to the furniture carcass 2 by way of a clipping mechanism. The furniture hinges 4 respectively include at least one linear damper 7 (not visible here) for damping a hinge movement, wherein the linear damper 7 is arranged at the outside of the hinge cup 5 and, in the installed position, beneath the fixing flange 8 of the hinge cup 5, wherein the hinge cup 5 together with at least one linear damper 7 arranged thereat can be arranged jointly within a preferably cylindrical bore provided in the door 3 and is arranged within a notional bore diameter of the bore.

FIGS. 2a and 2b show two different perspective views of the furniture hinge 4. The hinge cup 5 is pivotably connected to the hinge arm 6 by way of at least one hinged lever 9. The hinged lever 9 is connected to the hinge arm 6 by way of a hinge axis member 10, wherein towards the end of the closing movement of the furniture hinge 4, the axis member 10 immerses into the internal cavity of the hinge cup 5 and wherein the inwardly moving hinged lever 9 acts on a pivotably mounted actuating element 11 for driving a linear damper 7. In the illustrate embodiment, the actuating element 11 is pivotally mounted within the hinge cup 5 about an axis member 12, wherein the actuating element 11 is pivotable preferably through at least 90°. The actuating element 11, however, can also be linearly displaceably mounted. The hinge cup 5 has a fixing flange 8 for bearing against the door 3 (FIG. 1), wherein the housing 13 of the linear damper 7 is arranged at least partially externally on the hinge cup 5 and in the installed position beneath the fixing flange 8. There is provided a switch 30 which is to be actuated by a person for variably adjusting the damping force or for completely deactivating the damping function of the linear damper 7.

FIG. 3a shows a plan view of the furniture hinge 4, the hinge cup 5 and the fixing flange 8 being shown in broken-away form for reasons of clarity of the drawing. The hinge cup 5 is connected to the hinge arm 6 by way of at least one hinged lever 9, wherein towards the end of the closing movement of the furniture hinge 4, the hinged lever 9 acts on the actuating element 11 mounted rotatably about the axis member 12, wherein the movement of the actuating element 11 can be transmitted to the linear damper 7 by way of a transmission mechanism 14 (FIG. 4b). The housing 13 of the linear damper 7 is mounted laterally at the hinge cup 5 and beneath the fixing flange 8. The hinge arm 6 has a notional longitudinal axis X and the linear damping stroke Y of the linear damper 7 extends at an acute angle relative to the longitudinal axis X of the hinge arm 6. FIG. 3b shows an enlarged view of the region circled in FIG. 3a. As can be seen from this Figure, the angle α which is included between the longitudinal axis X of the hinge arm 6 and the linear damping stroke Y of the linear damper 7 is between 3° and 20° (preferably between 5° and 10°).

FIG. 4a shows the furniture hinge 4 in the open position, with the housing 13 of the linear damper 7 being shown in broken-away form. FIG. 4b shows an enlarged view of the region circled in FIG. 4a. The actuating element 11 to be acted upon by the hinged lever 9 is pivotally mounted about an axis member 12 within the hinge cup 5. A movement of the actuating element 11 can be transmitted to a ram 16 of the linear damper 7 by way of a transmission mechanism 14. In the illustrated embodiment, the transmission mechanism 14 includes a rotatably mounted lever 15 motionally coupled to the actuating element 11. The ram 16 is linearly displaceably mounted in a fluid chamber 17 in the housing 13. A compensating chamber 19 is in fluid-conducting communication with the fluid chamber 17, wherein mounted in the compensating chamber 19 is a deformable compensating body 20—which is preferably bag-shaped in a rest position—for compensating for a change in volume by virtue of the ram 16 immersing into the fluid chamber 17. After a damping stroke has occurred, the ram 16 and the actuating element 11 coupled thereto can be returned again by a return spring 18 arranged in the fluid chamber 17 into a ready position for the next damping stroke.

FIG. 5a shows a perspective view of the furniture hinge 4 in the closed position. FIG. 5b shows an enlarged view of the region circled in FIG. 5a, the housing 13 of the linear damper 7 being shown in broken-away form. The pivotally mounted lever 15 is also moved upon a movement of the actuating element 11, wherein the free lever end 21 of the lever 15 acts on the ram 16 and urges the ram 16 into the fluid chamber 17. The volume of the ram 16 immersing into the fluid chamber 17 is compensated by deformation of the compensating body 20 disposed in the compensating chamber 19. The ram 16 can be moved back again by the return spring 18, in which case the actuating element 11 is also returned to the starting position by that return movement by way of the rotatable lever 15. Reference 22 denotes an overload prevention means which, in the illustrated embodiment, has a spring-loaded ball. At least one overload opening can be opened between the fluid chamber 17 and the compensating chamber 19 by the overload prevention means 22 above a threshold value of a pressure acting on the ram 16, so that in the event of an overload, the damping fluid in the fluid chamber 17 can flow across into the compensating chamber 19 through the overload opening.

FIG. 6a shows a perspective view of the linear damper 7 with the actuating element 11 connected thereto. The actuating element 11 is non-rotatably connected to the rotatably mounted lever 15, wherein the free end 21 of the lever 15 bears loosely against the ram 16 of the linear damper 7. FIG. 6b shows an enlarged detail view of FIG. 6a. In the closing movement of the furniture hinge 4, the actuating element 11 is rotated, in which case the lever 15 also rotates and the ram 16 is pushed into the fluid chamber 17 of the housing 13 by the free end 21 of the lever 15.

FIG. 6c shows a perspective view of the rotatable lever 15, the free end 21 of the lever 15 cooperating with an end face of the ram 16 by way of an angle compensating device 23. That angle compensating device 23 serves to compensate for the inclined positioning of the linear damper 7 so that the ram 16 is acted upon in a straight line. In the illustrated embodiment, the surface of the free lever end 21, that is provided for contact with the ram 16, has an inclined surface 24 which upon contact with the ram 16 forms an acute angle β relative to the pivot axis member 12. That acute angle β preferably corresponds to the acute angle ° included between the longitudinal axis X of the hinge arm 6 and the direction of the linear damping stroke Y of the linear damper 7 (FIG. 3b).

FIG. 7a shows a further possible embodiment of an angle compensating device 23, by which the ram 16 of the linear damper 7 can be acted upon substantially in a straight line. In the illustrated Figure, the pivot axis member 12 has a positively locking contour 26 which differs from a cylindrical peripheral surface and which engages into an opening 25 in the rotatable lever 15. The opening 25 in the lever 15 has an inclined internal contour 28 corresponding thereto, wherein the guide surfaces of the internal contour 28 extend inclinedly relative to the side surface 27 of the lever 15. The ram 16 of the linear damper 7 can be acted upon in the axial direction by virtue of the inclined positioning of the lever 15 relative to the pivot axis member 12.

FIG. 7b shows a perspective view of the embodiment of FIG. 7a, wherein the lever 15 is non-rotatably connected by way of the positively locking contour 26 to the actuating element 11 to be arranged in the hinge cup 5, and wherein the side surface 27 of the lever 15 extends inclinedly relative to the side limb 29, which extends straight, of the actuating element 11. The angle compensating device 23 can alternatively also have a ball joint or also a cardan joint.

It should be noted that the linear damper 7 can also be used for damping an opening movement until the opened end position of the furniture hinge 4 is reached. If required, it is also possible to use a plurality of linear dampers 7 for damping a hinge movement, in which case an additional linear damper 7 can be arranged in mirror-image relationship with the longitudinal axis X shown in FIG. 3a of the hinge arm 6, at the opposite side wall of the hinge cup 5.

1. A furniture hinge comprising a hinge arm having a longitudinal axis, a hinge cup which is connected to the hinge arm and which is pivotally mounted relative to the hinge arm between a closed position and an open position, and a linear damper having a linear damping stroke for damping a movement of the furniture hinge, wherein the linear damper is arranged at the hinge cup and can be arranged jointly therewith in the installed position within a bore in a furniture part, wherein in the open position of the furniture hinge, in a plan view, the direction of the linear damping stroke of the linear damper extends at an acute angle relative to the longitudinal axis of the hinge arm, the acute angle being between 3° and 20°.

2. The furniture hinge according to claim 1, wherein the acute angle is between 5° and 10°.

3. The furniture hinge according to claim 1, wherein the hinge cup has a fixing flange for bearing against a furniture part, wherein the linear damper is arranged at least partially externally on the hinge cup and, in the installed position, beneath the fixing flange.

4. The furniture hinge according to claim 1, wherein the hinge cup is connected to the hinge arm by way of at least one hinged lever, wherein the hinged lever immerses into the hinge cup in the closing movement of the furniture hinge.

5. The furniture hinge according to claim 4, wherein arranged in or on the hinge cup is a moveably, preferably pivotally, mounted actuating element for driving the linear damper, wherein the hinged lever acts on the actuating element in the closing movement of the furniture hinge.

6. The furniture hinge according to claim 5, wherein the actuating element is pivotally mounted about an axis member within the hinge cup, wherein in a plan view, that region of the hinge cup into which the hinged lever immerses in the closing movement, is widened in relation to that region of the hinge cup, at which the axis member of the actuating element is arranged.

7. The furniture fitting according to claim 5, wherein the actuating element is motionally coupled to the linear damper by way of a transmission mechanism.

8. The furniture hinge according to claim 7, wherein the transmission mechanism has at least one pivotally mounted lever motionally coupled to the actuating element, wherein a displaceably mounted ram of the linear damper can be acted upon by the pivotally mounted lever.

9. The furniture hinge according to claim 8, wherein the pivotally mounted lever cooperates with the ram of the linear damper by way of an angle compensating device, wherein the ram of the linear damper can be acted upon substantially in a straight line by the angle compensating device.

10. The furniture hinge according to claim 9, wherein the angle compensating device has an inclined surface operative between the pivotally mounted lever and the ram.

11. The furniture hinge according to claim 9, wherein the angle compensating device has an opening arranged on the pivotable lever and having an inclined internal contour, into which engages a positively locking contour of the pivot axis member, said contour differing from that of a cylindrical peripheral surface.

12. The furniture hinge according to claim 1, wherein the linear damper has a housing with a fluid chamber formed therein, wherein at least one ram is displaceably mounted in the fluid chamber, wherein a relative movement between the fluid chamber and the ram occurs in the damping stroke of the linear damper.

13. The furniture hinge according to claim 12, wherein the linear damper has a return spring which is preferably mounted in the fluid chamber, and by which the ram after a damping stroke has taken place can be returned again to a ready position for the next damping stroke.

14. An article of furniture comprising a furniture carcass and a moveable furniture part which is mounted pivotably relative to the furniture carcass by way of at least one furniture hinge according to claim 1.
